(19) United States
(12) Patent Application Publication
(10) Pub. No.: US 2022/0162498 A1
(43) Pub. Date: May 26, 2022

(54) METHOD FOR IMPROVED OIL RECOVERY IN SUBTERRANEAN FORMATIONS WITH CIRCUMNEUTRAL pH FLOOD

(71) Applicant: Halliburton Energy Services, Inc., Houston, TX (US)

(72) Inventors: Antonio RECIO, III, Houston, TX (US); Enrique Antonio REYES, Houston, TX (US); Aaron Michael BEUTERBAUGH, Houston, TX (US); Denise Nicole BENOIT, Houston, TX (US)

(21) Appl. No.: 17/527,736

(22) Filed: Nov. 16, 2021

Related U.S. Application Data
(60) Provisional application No. 63/117,832, filed on Nov. 24, 2020.
(60) Provisional application No. 63/117,834, filed on Nov. 24, 2020.
(60) Provisional application No. 63/117,839, filed on Nov. 24, 2020.

(51) Int. Cl. C09K 8/584; C09K 8/594

(52) U.S. Cl. CPC C09K 8/584; C09K 8/594

(57) ABSTRACT

A method of enhanced oil recovery comprising placing into a subterranean formation a treatment fluid comprising (i) a compound comprising a phosphonoalkyl moiety; and (ii) a base fluid wherein a pH of the treatment fluid ranges from about 5 to about 9 wherein the treatment fluid is placed into the subterranean formation via one or more injection wells and travels a distance into the subterranean formation in a direction of one or more recovery/production wells. A method of servicing a wellbore comprising introducing a treatment fluid comprising a pore-connectivity enhancer comprising a phosphonoalkyl moiety; (a) a surfactant composition comprising a fatty acid alkoxylate, an amine oxide, alkanolamide, an alkoxylated alcohol, an alkylamine alkoxylate, an alkyl glycoside surfactant or a combination thereof; and a base fluid, wherein the composition has a pH of from about 5 to about 9 and wherein introducing comprises thermal injection, gas injection or chemical injection,

### CROSS-REFERENCE TO RELATED APPLICATIONS

This application claims priority under 35 U.S.C. § 119(e) to U.S. Provisional Patent Application No. 63/117,832 filed on Nov. 24, 2020 and entitled “Method for Improved Oil Recovery in Subterranean Formations with Circumneutral pH Flood,” U.S. Provisional Patent Application No. 63/117,834 filed on Nov. 24, 2020 and entitled “Composition and Methods for Improving Hydrocarbon Mobility in Enhanced Oil Recovery Operations,” and U.S. Provisional Patent Application No. 63/117,839 filed on Nov. 24, 2020 and entitled “Method for Improved Oil Recovery in Unconventional Subterranean Formations,” the disclosure of each of which is hereby incorporated herein by reference in its entirety.

### FIELD

This application relates to the recovery of natural resources from a wellbore penetrating a subterranean formation, and more specifically this application relates to compositions and methods used in improved or enhanced oil recovery (EOR) operations.

### BACKGROUND

Natural resources such as gas, oil, and water residing in a subterranean formation or zone are usually recovered by drilling a wellbore down to the subterranean formation. Primary recovery refers to the first stage of hydrocarbon production, in which natural reservoir energy displaces hydrocarbons from the reservoir into the wellbore. initially, the reservoir pressure is considerably-higher than the bottomhole pressure inside the wellbore. This high natural differential pressure drives hydrocarbons toward the well and up to the surface. However, as the reservoir pressure declines because of production, so does the differential pressure. To reduce the bottomhole pressure or increase the differential pressure to increase hydrocarbon production, it typically becomes necessary to implement an artificial lift system, such as a rod pump, an electrical submersible pump or a gas-lift installation. The primary recovery stage reaches its limit either when the reservoir pressure is so low that the production rates are not economical, or when the proportions of gas or water in the production stream are too high. During primary recovery, only a small percentage of the initial hydrocarbons in place are produced, typically around 10% for oil reservoirs.

Following primary recovery, a variety of improved or enhanced oil recovery (EOR) operations may be carried out. Typically, in these systems the implementation of Enhanced Oil Recovery (EOR) processes is not economical, technically feasible, or robust enough to implement. Thus, methods and compositions to improve EOR in these formations are desired.

### BRIEF DESCRIPTION OF DRAWINGS

For a more complete understanding of this disclosure, reference is now made to the following brief description, taken in connection with the accompanying drawings and detailed description, wherein like reference numerals represent like parts.

FIG. 1 shows the results from a spontaneous inhibition experiment where the oil produced or recovered from a core is measured as a function of time (days) for samples from Example 1.

FIGS. 2A and 2B are scanning electron microscopy images of a cross section of the samples from Example 2.

FIGS. 3A and 3B show depictions of surfaces treated with the compositions of Example

FIG. 4 shows the pressure response during dynamic scale tests for samples from Example 4.

FIG. 5 illustrates the percentage hydrocarbon recovery in Indiana Limestone Oil-wetted Cores for samples from Example 4.

### DETAILED DESCRIPTION

Disclosed herein are novel methods and compositions for hydrocarbon recovery, alternatively enhanced oil recovery (EOR). Particularly disclosed herein are methods and compositions for formation flooding (surfactant flooding) in fractured formations, high-contrast formations or both. In one or more embodiments, EOR is carried out in one or more stages. Each of these stages may involve introduction of one or more treatment fluids to the fractured formations, high-contrast formations or both. Subsequent to introduction of the one or more treatment fluids of the type disclosed herein, a period of time may be allowed to elapse sufficient to allow the composition to carry out its intended function.

In some embodiments, EOR as carried out herein employs treatment fluids having a multifunctional additive comprising a phosphonoalkyl moiety. Without wishing to be limited by theory, the multifunctional additive comprising a phosphonoalkyl moiety may, when placed downhole, serve to improve the connectivity between the permeable areas of the formation. Herein the multifunctional additive comprising a phosphonoalkyl moiety is designated a MAP.

In some embodiments, a treatment fluid comprises a MAP and a base fluid. In the alternative, the treatment fluid comprises (i) a MAP, (ii) a base fluid, and (iii) a surfactant; alternatively (i) a MAP, (ii) a base fluid, and (iii) a polymer; or alternatively (i) a MAP, (ii) a base fluid, (iii) a surfactant, and (iv) a polymer.

In some embodiments, a MAP suitable for use in a treatment fluid according to the present disclosure is a phosphonoalkyl aminopolycarboxylic acid having the general formula

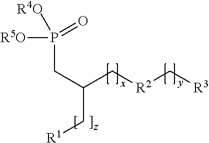

where R¹ is selected from an alkyl having from 1 to 10 carbon atoms, an alkenyl having from to 10 carbon atoms, an alkynyl having from 1 to 10 carbon atoms, an acyl, an aryl, an acetate, a phosphonate, or a hydrogen atom; R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom; R³ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonoalkyllamine, or a hydrogen atom; R⁴ is selected from an alkyl haying from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom; R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom; x is 1 to 6; y is 0 to and z is 1-6.

Nonlimiting examples of MAPs suitable for use in the present disclosure include N-(phosphonomethyl) iminodiacetic acid (PMIDA) or salts thereof, N-(carboxymethyl)-N-(phosphonomethyl)glycine, glycine, N,N′-1,2-ethanediylbis(N-(phosphonomethyl), glyphosine, aminotrimethylene phosphoric acid, sodium aminotris(methylenephosphonate), N-(2-hydroxyethyl)iminobis (methylphosphonic acid), phosphonic acid, P,P′-((2-propen-1-ylimino)bis(methylene))bis-phosphonic acid, P,P′,P″-(nitrilotris(methylene))tris-(nitrilotris(methylene))trisphosphonic acid, ((methylimino)dimethylene)bisphosphonic acid, P,P′,P″,P′″-(oxybis(2,1-ethanediylnitrilobis(methylene))tetrakis-((propylimino)bis(methylene))diphosphonic acid, P,P′,P″-(nitrilotris(methylene))tris-(ethylenedinitrilo)-tetramethylenephosphonic acid, ethylene-bis(nitrilodimethylene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl) amino)hexanoic acid, (phenylmethyl)imino)bis(methylene)bisphosphonic acid, phosphonobutane tricarboxylic acid, 2-hydroxyphosphono dicarboxylic acid, or a combination thereof. In some embodiments, the treatment fluid comprises PMIDA.

In some embodiments, the MAP is a metallated mono- or di-acetoaminophosphonate comprising a cation of Li, Na, K, Cs, Mg, Ca, Sr, Ba, Cr, Fe, Mn, Co, Ni, Cu, Ti, Zn, Zr, Ga, Al, In or a combination thereof. In some embodiments, the MAP is a non-metallated diacetoaminophosphonate comprising a nonmetal selected from the group consisting of hydrogen ions, ammonium ions, tetraalkylammonium ions, tetraalkylphosphonium ions, a mono-, di-, or tri-alkanolamine wherein the alkyl species of the alkanol functionality can be methyl-, ethyl-, an isomer of propyl or an isomer of butyl, a nucleophile, an electrophile, a Lewis acid, a Lewis base, a Bronsted acid, a Bronsted base, an adduct of a stable complex ion, an electron donor and combinations thereof Furthermore, under the appropriate acid/base conditions a zwitterionic species of the MAP that can form hydrogen bridges with nucleophiles, such as Lewis bases, Bronsted bases, or form adducts where an electron donor-electron acceptor pair is stable. Such species, nucleophiles or electron donor-acceptor, may comprise a monoalkanolamine, dialkanolamine or trialkanolamine for instance; where the alkyl species of the alkanol functionality can be methyl group, ethyl group, an isomer of a propyl group or a butyl group.

The MAP may be present in the treatment fluid in an amount of from about 0.001 wt. % to about 15 wt. %, alternatively from about 0.001 vol. % to about 10 vol. %, alternatively from about 0.05 vol. % to about 10 vol. % or alternatively from about 0.5 vol. % to about 5 vol. % based on a 1000 gal aqueous treatment stage, wherein the aqueous treatment stage can be continuously injected, injected as a main pill or stage, or injected in alternating stages or in intervals.

In some embodiments, the treatment fluid comprises a base fluid such as an aqueous fluid. The aqueous fluid may comprise fresh water, salt water, deionized water, produced water, flowback water, brackish water, brine, seawater or a combination thereof. The aqueous fluid may comprise salt in an amount of less than about 40,000 ppm, alternatively from about 4,000 ppm to about 40,000 ppm or alternatively from about 2,000 ppm to about 20,000 ppm. The salt may be selected from the group consisting of sodium bromide, calcium chloride, calcium bromide, cesium bromide, zinc bromide, potassium chloride, sodium chloride, a carbonate salt, a sulfonate salt, a phosphate salt, a phosphonate salt, a magnesium salt, a bromide salt, a formate salt, an acetate salt, thiophosphate salts, phosphate salts, phosphonate salts, a nitrate salt and a combination thereof. The aqueous fluid may be present in the treatment fluid an amount of from about 0.01 weight percent (wt. %) to about 99 wt. %, alternatively from about 0.5 wt. % to about 5 wt. % or alternatively from about 1.0 wt. % to about 2.0 wt. % based on the total weight of the treatment fluid or may comprise the rest of the treatment fluid when all other components are taken into account.

A treatment fluid of the type disclosed herein may further comprise a surfactant. In some embodiments, the surfactant comprises a fatty acid alkoxylate, an amine oxide, alkanolamide, an alkoxylated alcohol, an alkylamine alkoxylate, an alkyl glycoside surfactant or a combination thereof. In some embodiments, the surfactant comprises Guebert alcohols.

Guerbet alcohols refer to a C₈ to C₂₅ β-alkylated dimer alcohols alkoxylated with ethylene oxide (EO), propylene oxide (PO), a mixture of both, or blocked to control oil/water solubility; wherein the blocked alcohol is a product of reacting a mixture of ethylene oxide and propylene oxide of varying concentrations and the product(s) is determined by entropic and electrophilic factors. Such process entails the sequential treatment of alcohols with first EO, then PO.

Extended surfactants are a class of molecules that undergo a sulfonation reaction after an alcohol has been subjected to sequential EO, followed by PO, or visa versa additions, to attenuate the lipophilicity of the molecule The moles of EO may range from about 1 mole to about 55 moles, alternatively from about 4 moles to about 40 moles or, alternatively from about 6 moles to about 22 moles based on the amount of alcohol and moles of PO may range from about 1 mole to about 55 moles, alternatively from about 4 moles to about 40 moles, or alternatively from about 6 moles to about 22 moles based on the amount of alcohol.

in some embodiments, the surfactant comprises a C₈ to C₂₅ β-alkoxylated dimer alcohol having an ethoxylate moiety and a propoxylate moiety present in ratio of from about 4:1, alternatively from about 2:1, alternatively from about 1:1, alternatively from about 1:2, or alternatively from about 1:4. In some embodiments, the C₈ to C₂₅ β-alkoxylated dimer alcohol comprises 2-butyloctanol, 2-hexyldecanol or a combination thereof

In some embodiments, the surfactant is a demulsifying surfactant. Examples of demulsifying surfactants suitable for use in the treatment fluid include without limitation polyols, alkoxylated polyols, resin alkoxylates, alkoxylated phenol formaldehydes alkyl resin, polyaminopolyethers, polyether amines, or a combination thereof.

In sonic embodiments, the surfactant is present in the treatment fluid in an amount of from about 0.01 vol. % to about 10 vol. %, alternatively from about 0.1 vol. % to about 5 vol. % or alternatively from about 0.5 vol. % to about 2.5 vol. % based on 1,000 gallons of treatment fluid.

In some embodiments, the treatment fluid excludes a surfactant; alternatively comprises less than about 10 wt. %, alternatively less than about 9 wt. %, alternatively less than about 8 alternatively less than about 7 wt. %, alternatively less than about 6 wt. %, alternatively less than about 5 wt. %, alternatively less than about 4 wt. %, alternatively less than about 3 wt. %, alternatively less than about 2 wt. %, alternatively less than about 1 wt. % surfactant, alternatively less than about 0.1 wt. % surfactant, alternatively less than about 0.01 wt. % surfactant, or alternatively less than about 0.001 wt. % surfactant based on the total weight of the treatment fluid.

In one or more embodiments, the treatment fluid comprises a polymer. Examples of polymers suitable for use in the treatment fluid include without limitation partially hydrolyzed polyacrylamide, terpolymers derived of monomers containing esters and amides of alcohols, alkoxylated alcohols, propoxylated alcohols, amines, alkyoxylated amines, propoxylated amines, alkyl amines, alkyl sulfonates, alkyl phosphonates, quaternary amines, alkylsilanes, and a combination thereof. In such embodiments, the polymer is present in the treatment fluid in an amount of from about 5 mg/L (0.05 wt. %) to about 15,000 mg/L (15% wt. %), alternatively from about 0.5 wt. % to about 5 wt. % or alternatively from about 0.1 wt. % to about 1 wt. % based on the total weight of the treatment fluid.

Tn some embodiments, the treatment fluid excludes a. polymer; alternatively comprises less than about 10 weight percent (wt. %), alternatively less than about 9 wt. %, alternatively less than about 8 wt. %, alternatively less than about 7 wt. %, alternatively less than about 6 wt. %, alternatively less than about 5 wt. %, alternatively less than about 4 wt. %, alternatively less than about 3 wt. %, alternatively less than about 2 wt. %, alternatively less than about 1 wt.? polymer, alternatively less than about 0.1 wt. % polymer, alternatively less than about 0.01 wt. % polymer, or alternatively less than about 0.001 wt. % polymer based on the total weight of the treatment fluid.

In some embodiments, a treatment fluid suitable for use in the present disclosure excludes a chelant. In some embodiments, a treatment fluid suitable for use in the present disclosure comprises less than about 1 wt. %, alternatively less than about 0.5 wt. %, alternatively less than about 0.1 wt. %, alternatively less than about 0.01 wt. %, or alternatively less than about 0.001 wt. % of a chelant based on the total weight of the treatment fluid. In some embodiments, the treatment fluid comprises less than about 10, 1.0, 0.1, 0,01, or 0.001 wt. % of ethylenediaminetetraacetic acid (EDTA), diethylenetriaminepentaacetic acid (DTPA), glutamic acid di-acetate (GLDA), methylglycinediacetic acid (MGDA), ethylenediamine-N,N′-disuccinic acid (EDDS), hydroxyiminodisuccinic acid (HMS), hydroxyethylethylenediaminetriacetic acid (HEDTA), pentasodium diethylenetriaminepentaacetate (Na₅DPTA. DPTA), pentapotassium diethylenetriaminepentaacetate (K₅DPTA, DPTA), diethylenetriaminepentaacetic acid (H₅DPTA, DPTA), N,N-diacetic acid, tetrasodium (GLDA Na₄), glutamic acid, (3-alanine diacetic acid (β-ADA), polyamino disuccinic acids, N-bis[2-(1,2-dicarboxyethoxy)ethyl]glycine (BCA6), N-bis[2-(1,2-dicarboxyethoxy)ethyl]aspartic acid (BCA5), N-bis[2-(1,2-dicarboxyethoxy)ethyl]methylglycine (MCBA5), N-tris[(1,2-dicarboxyethoxy)ethyl]amine (TCA6), N-bis[2-(carboxymethoxy)ethyl]glycine (BCA3), N-bis[2-(methylcarboxymethoxy)ethyl]glycine (MCBA3), N-methyliminodiacetic acid (MIDA), irninodiacetic acid (IDA), N-(2-acetamido)iminodiacetic acid (ADA), hydroxymethyl-iminodiacetic acid, 2-(2-carboxyethylamino) succinic acid (CEAA), 2-2-carboxymethylamino) succinic acid (CMAA), diethylenetriamine-N,N″-disuccinic acid, triethylenetetr mine-N,N′″-disuccinic acid, 1,6-hexamethylenediamine-N,N′-disuccinic acid, tetraethylenepentamine-N,N″″-disuccinic acid, 2-hydroxypropylene-1,3-diamine-N,N-disuccinic acid, 1,2-propylenediamine-N,N′-disuccinic acid, 1,3-propylenediamine-N,N′-disuccinic acid, cis-cyclohexanediamine-N,N′-disuccinic acid, trans-cyclohexanediamine-N,N′-disuccinic acid, ethylenebis(oxyethylenenitrilo)-N,N′-disuccinic acid, glucoheptanoic acid, cysteic acid-N,N-diacetic acid, cysteic acid-N-monoacetic acid, alanine-N-monoacetic acid, N-(3-hydroxysuccinyl) aspartic acid, N-[2-(3-hydroxysuccinyl)]-L-serine, aspartic acid-N,N-diacetic acid, aspartic acid-N-monoacetic acid, hydroxyethyliminodiacetate (HEIDA), iminodiacetic acid (IDA), nitrilotriacetic acid (NTA), polyhydroxy carboxylic acids, citric acid, glycolic acid, lactic acid, maleic acid, gluconic acid, glucaric acid, salts thereof or a combination thereof. Without wishing to be limited by theory, the use of chelants (e.g., NTA) that exhibit dissolution activity can further change the contact angle of the treatment fluid with the surface of the formation (e.g., pore surface and/or fracture surface).

In some embodiments, the pH of the treatment fluid may be from about 5 to about 9 or from about 6.5 to about 8.5. Herein the pH takes its standard definition as an indication for the acidity of a substance. The outcome of a pH-measurement is determined by a consideration between the number of H⁺ ions and the number of hydroxide (OH—) ions. When the number of H⁺ ions equals the number of OH⁻ ions, the fluid is neutral and then has a pH of about 7. The pH of the solution may be determined using any suitable methodology such as through the use of a pH electrode or indicator media.

In some embodiments, treatment fluids of the type disclosed herein are used in EOR treatments and thereby function to address hydrocarbon mobility (particularly oil) and recovery (extraction) from fractured formations, high-contrast formations or both. In some embodiments, the reservoir subjected to EOR is a fractured carbonate reservoir. Fractured carbonate reservoirs are among the most challenging reservoirs to improve or just economically get recovery of because flow distribution can be unpredictable. Unpredictable flow distribution magnifies treatment costs and requires large concentrations of chemical additives due to both the large volume necessary to flood or sweep a reservoir and the cost of such chemicals.

In some embodiments, the reservoir subjected to EOR is a sandstone reservoir. Sandstone reservoirs are not normally naturally-fractured and have formations characterized by an ultralow porosity leading to the development of massive fracturing techniques in very long horizontal wells (shales or unconventionals). These reservoirs typically utilize massive volumes of fluid with highly optimized and efficient chemical packages (frac-fluid).

In some embodiments, the reservoir subjected to EOR is a nonconventional reservoir which is defined as any subterranean formation that has, or comprises, one of: (i) fractured reservoirs where the fracture can be naturally present or artificially created (hydraulic fracturing, “fracking”), (ii) the primary porosity is less than 10% (tight formations); (iii) high contrast reservoirs which can be a network of fractures or naturally present conduits or paths that provide hydraulic transport; or (iv) any combination of (i) (iii). In this context, there are discontinuous regimes of permeability that give rise to substantial differences, or contrast, of permeability domains. This is observed in reservoirs having permeability spanning nanodarcy to darcy scales. For example, the permeability of these reservoirs may range from about 1×10³ darcy to about 1×10⁻¹⁰ darcy, alternatively from about 1×10¹ darcy to about 1×10⁻⁴ darty or alternatively from about 1×10⁻¹ darcy to about 1×10⁻³ darcy.

In some embodiments, a method of the present disclosure comprises flooding (e.g. surfactant flooding) of a formation (e.g., high contrast, treated formation) with a treatment fluid of the type disclosed herein. Surfactant flooding is an EOR technique applied for decreasing capillary effects by molecular performance alterations on water-oil interface between injected water and displaced oil. In most situations, this method is implemented as a tertiary flood near of the end of waterflooding but it could be conducted after the initial stage of field production when oil saturations are high in the porous media.

In such embodiments, the method for formation flooding (e.g., surfactant flooding) comprises introduction to the formation a treatment fluid of the type disclosed herein that facilitates communication between the pores of the formation. For example, in a method of surfactant flooding, the treatment fluid may comprise (i) a MAP, (ii) a surfactant and (iii) a base fluid, each of the type disclosed herein.

In some embodiments, a method of the present disclosure comprises introducing the treatment fluid to the wellbore (and adjacent formation) and conducting the surfactant flooding at circumneutral pH. In general, circumneutral describes a near neutral pH condition in a. formation For example, mine drainage having a pH from 6 to 8 is described as being circumneutral. Surfactant flooding at circumneutral pH avoids the need to increase the pH of the main stage or pill (e.g., the primary or largest volume of stimulation fluid pumped into the formation via one or more injection wells), which lowers the interfacial tension of the injected fluids with the reservoir mineral matrix.

In some embodiments of carrying out an EOR operation, the treatment fluid is placed into the subterranean formation via one or more injection wells and travels a distance into the subterranean formation in a direction of one or more recovery/production wells to aid in the mobilization and removal of hydrocarbons from the reservoir via the recovery/production wells. Placement of the treatment fluid into the one or more injection wells may occur using any suitable EOR methodology such as thermal injection, steam injection, steam flooding, or tire flooding (e.g., situin combustion within the formation); gas (e.g., carbon dioxide, natural gas, or nitrogen) injection also referred to as miscible flooding; or chemical injection (e.g., water flooding with one or more chemical additives such as surfactants, polymers, alkaline or caustic agents, etc.). In various embodiments, EOR techniques of the type disclosed herein((e.g., formation flooding, surfactant flooding, continuous injection waterflooding, cyclic injection, etc.) can be used on reservoirs of the type disclosed herein (e.g., fractured carbonate reservoirs, sandstone reservoirs, unconventional reservoirs, fractured formations, high-contrast formations, etc) using a treatment fluid of the type disclosed herein (e.g., a treatment fluid comprising (i) a MAP and (ii) a base fluid; alternatively (i) a MAP, (ii) a base fluid, and (iii) a surfactant; alternatively (i) a MAP, (ii) a base fluid, and (iii) a polymer; or alternatively (i) a MAP, (ii) a base fluid, (iii) a surfactant, and (iv) a polymer).

In other embodiments, the methods disclosed herein utilize established or conventional EOR technologies which are implemented by injecting the treatment fluid through an injection well, displacing or forcing the treatment fluid through the reservoir (sweep treatment) where the treatment fluid contacts and mobilizes (sweeps) hydrocarbons in the formation, and extracting the hydrocarbon and said treatment fluid through one or more production wells. It is to be understood that the treatment fluid (e.g., aqueous treatment fluid) helps to drive hydrocarbon recovery, an effect known as ‘sweep’. This effect is further improved by the use of viscous fluids, for example a treatment fluid of the type described herein comprising a polymer (and may be referred to as polymer flooding). In one or more embodiments, these viscous fluids can include polymers (partially hydrolyzed polyacrylamide, xanthan, etc.), surfactants such as Guerbet alcohols.

Any treatment fluid disclosed herein may be used in a continuous injection waterflood. For example, the treatment fluid may be continuously injected, under pressure, into reservoir rock formations via one or more injection wells (e.g., a plurality of injection wells). The injected treatment fluid may act to help maintain reservoir pressure and sweep through the formation located between the injection and one or more production/recovery wells (e.g., a plurality of production wells) from which the oil is recovered. As the injected treatment fluid sweeps through the formation toward the production wells, it forms a flood front (e.g., an interface between the injected fluid and the hydrocarbons being displaced ahead of it) that travels through the rock towards the production/recovery wells. A combination of reservoir hydrocarbons and treatment fluid is recovered from the production wells, for example continuously recovered from the production wells at a rate about equal to the continuous injection into the injection wells. In some embodiments, the treatment fluid injection and recovery of at least a portion of the treatment fluid by the production wells occurs about concurrently and about continuously (e.g., with no or minimal disruptions), for example over a period of equal to or greater than 1, 3, or 4 weeks; 1, 3, 4, 5, 6, 8, 9, 10, 11, or 12 months; or 1, 2, 3, 4, 5, 6, 7, 8, 9, or 10 years, which may be referred to as continuous injection waterflooding. The treatment fluids of the present disclosure when used in coatinuous injection waterfloods advantageously (i) rapidly water wet the reservoir surface; (ii) reactively etch small layers/particles from the formation to improve sweep efficiency; (iii) are compatible with polymers if more viscosity is needed; (iv) enhance recovery of hydrocarbons from the subterranean formation, particularly in oil-wet formations; and (v) combinations of (i)-(iv).

In some embodiments, EOR comprises cyclic injection wherein the treatment fluid (e.g., an aqueous fluid or a foamed fluid containing chemical agents of the type described herein) is introduced to the subterranean formation via cyclic injection to enhance hydrocarbon recovery from the reservoir matrix. In cyclic injection, the treatment fluid is injected into one or more injection wells for a first period of time (an injection time interval), the injection is halted (and optionally the injected fluid is allowed to “soak” in the reservoir for a period of time (e.g., a soak time interval), and then fluid is recovered (e.g., treatment fluid and reservoir hydrocarbons are recovered) from one or more production wells for a second period of time (a production time interval). The injection, optional soak, and production periods of time combined constitute an injection/soak/production cycle, and the EOR process may comprise a plurality of sequential cycles that may be continuous or spaced apart by time periods such a minutes, hours, or days.

In yet other embodiments, EOR comprises cyclic injection using a treatment fluid of the type disclosed herein in combination with water or a foamed fluid to enhance hydrocarbon recovery from the reservoir matrix in a multi-well scenario. Herein a multi well scenario refers to an operation where a plurality of wells in close proximity to each other are injected and produced in a pattern to help maintain reservoir pressure and enhance overall recovery from a larger reservoir utilizing multiple well interaction.

In some embodiments, a treatment fluid of the type disclosed herein can be used for carrying out an EOR under a non-fracturing injection mode. For example, the treatment fluid may be introduced to the formation through coiled tubing (CT) conveyed into the wellbore, and fluid is introduced to the formation at a pressure below the fracturing pressure of the formation such that the formation is not fracturing during placement of the treatment fluid via the CT. CT refers to a continuous string of tubing, rolled onto a spool. CT is made from rolling strip material into a tubular form and resistance welding along its length. Upon its manufacturing, coiled tubing is rolled onto large spools with core diameters ranging from 8-12 feet. The strip material of CT is joined together using carefully controlled bias welding processes, such that the final string has no visible butt welds. Coiled tubing outer diameters generally range from about 0.75-in to about 4.5-in. Coiled tubing material is essentially carbon steel, modified for grain size refinement.

Introduction of the treatment fluid to the formation via the CT provides the ability to quickly move in and out of the formation (or be quickly repositioned) when fracturing multiple zones in a single well. CT also provides the ability to facture or accurately spot (i.e., place) the treatment fluid to ensure complete coverage of the zone of interest. When used in conjunction with an appropriate diversion technique, more uniform treating of long target zones can he achieved. This is particularly useful in horizontal wellbores. In such embodiments (e.g., non-fracturing injection mode via CT), the treatment fluid may not be recovered and/or is not flowed back.

In some embodiments, continuous injection waterflooding with treatment fluids of the present disclosure is employed as an alternative to conventional Low Salinity Water (LSW) flooding technology. A low salinity water flood is very difficult to design due to its reliance on the formation and crude oil characteristics, and the need for specific and quality types or grades of water (base fluid). The treatment fluids of the present disclosure advantageously provide for fluids able to increase oil recovery while maintaining wellbore integrity. LSW fluids mobilize hydrocarbons from clay surfaces and utilize free clay fines as a viscosifier and diverter to improve sweep efficiency for the flood. However, a LSW having too low of a salinity will result in clay fines that block the reservoir pores whereas introduction of too high a salinity fluid will cause high surfaces to remain oil wet. The treatment fluids of the present disclosure when used in continuous injection waterfloods advantageously (i) rapidly water wet the reservoir surface; (ii) reactively etch small layers/particles from the formation to improve sweep efficiency; (iii) are compatible with polymers if more viscosity is needed; (iv) enhance recovery of hydrocarbons from the subterranean formation, particularly in oil-wet formations; and (v) combinations of (i)-(iv).

In some embodiments, a treatment fluid of the type disclosed herein is used under non-fracturing injection mode, such as (a) continuous injection floods as described herein or (b) via injection through CT deployed within one or more injection wells, in which case the injected fluid is not recovered and/or is not flowed back.

In other embodiments, established or conventional EOR technologies are implemented by injecting the treatment fluid through one or more injection wells, displacing or forcing the treatment fluid through the reservoir (sweeping the reservoir), and extracting the hydrocarbon and said treatment fluid through one or more production wells. It is understood that water helps to sweep that accompanies a “flood front” as the injectant travels through the formation located between the injection and production wells. This effect is further improved, necessarily, by the use of viscous fluids (e.g., polymers in what may be referred to a polymer flooding).

In some embodiments, a treatment fluid of the type disclosed herein is utilized as an alternative to Low Salinity Water (LSW) in a continuous injection waterflood operation, are typically employed to compatibilize the salinity to below the brine content of the reservoir which may improve water wetting of the surface and mobilize hydrocarbons.

In some embodiments, a continuous injection waterflood with a treatment fluid of the type disclosed herein will be an improvement over traditional LSW. Without wishing to be limited by theory a treatment fluid of the type disclosed herein of the present disclosure may provide an improved imbibition into matrix. Further, even within tight pores a treatment fluid of the type disclosed herein is expected to have deeper transport of the fluids over a high or low-salinity brine and this deep penetration will better contact the reservoir.

In some embodiments, an increased displacement of oil from the reservoir can be achieved with a treatment fluid of the present disclosure. It is to be understood that inducing fluid displacement can also require physical forces acting on such reservoir fluids. This is typically achieved utilizing surfactants to reduce surface tension between hydrocarbon and the formation and/or polymers that can generate drag as they travel through the formation.

For example, based on laboratory spontaneous imbibition data, use of a treatment fluid of the type disclosed herein during EOR may result in an increased % hydrocarbon recovery from about 1% to about 300%, alternatively frorri about 5% to about 100% or, alternatively from about 10% to about 50%.

In some embodiments, a treatment fluid of the type disclosed herein facilitates the transport of surfactants, including non-emulsified surfactants, and compositions into areas or sections of a subterranean formation that are not normally accessible to the treatment fluid when compared to otherwise similar operations carried out in the absence of the herein disclosed treatment fluids. In such embodiments, the presence of the treatment fluid may increase displacement of produced fluids from the formation such as water, in addition to hydrocarbons.

In embodiments where the surfactant compositions present in the treatment fluid include one or more demulsifying surfactants, utilization of the treatment fluid in EOR may reduce or eliminate emulsions in fluids produced from a subterranean formation thereby providing demulsification and permeability improvement for swept or produced fluids.

Conventionally, surfactant compositions for EOR are designed to reduce interfacial tension and are not designed to demulsify in-situ. The compositions of the present disclosure make use of existing capillary forces in order to generate viscous forces. In conventional EOR scenarios, an emulsion, Windsor TYPE II or TYPE III emulsions is formed to create a chemical bank in order to improve “sweep” of the formation and to maximize the displacement of hydrocarbon from the matrix, The chemical bank is pushed by an injection well/source or gravity, these are referred to as “viscous forces.” The chemical formulation also needs to perturb “capillary forces” or essentially reduce the capillary pressure in the matrix in order to maximize hydrocarbon mobility. In both cases, the oil/water interfacial tension is reduced. Reducing capillary pressure because of a reduced oil/water interfacial tension, changing the wettability of the formation surface (contact angle reduction), and changing the radius of curvature of the pore network, will all lead to perturbation of capillary forces.

In other embodiments, a treatment fluid of the present disclosure forms a scale inhibitor when placed in a formation. In such embodiments, the treatment fluid comprises a MAP as a free base (i.e., in the absence of a counteraction) and a base fluid. Within the formation, the MAP may contact a divalent cation (e.g., Ca²⁺) and the resultant compound (i.e., MAP-divalent cation complex) formed in situ inhibits the formation of scale on surfaces.

In such embodiments, the method of inhibiting formation of scale in a subterranean formation includes providing a treatment fluid into the subterranean formation. In such embodiments, the treatment fluid provides protection against scaling, for example calcium scales and magnesium scales, even in high temperature environments (e.g., about 115° F. and higher). Advantageously, the treatment fluid is substantially free (e.g., less than 0.5% by weight) or entirely free of an additional acid or acid-generating compound, which can cause corrosion and require the use of corrosion inhibitors.

In such embodiments, the treatment fluid is used in an amount effective to produce some user and/or process goal, for example an amount effective to reduce an amount of scale present on a downhole surface and/or inhibit an amount of scale forming on the downhole surface (e.g., a formation surface, a fracture surface, a pore surface, an equipment surface (e.g., pump surface, valve surface, heater surface), a conduit surface a pipe surface, a casing surface, a tubing surface, a production pipe/tubing surface, a heating coil surface), a proppant surface, a proppant pack surface, etc.). According to several exemplary embodiments, an effective amount of the treatment fluid is dependent on one or more conditions present in the system to be treated, as would be understood by one of ordinary skill in the art. The effective amount may be influenced, for example, by factors such as the area subject to deposition, temperature, water quantity, and the respective concentration in the water of the potential scale and deposit forming species.

In other embodiments, the treatment fluid comprising a MAP and base fluid is capable of operating in high solid content brine, such as high total dissolved solids (TDS) produced waters, where traditional compositions do not function effectively, and the produced water has to be mixed (or cut) with fresh water. Thus, the treatment fluid (e.g., upon contact with a downhole surface) is highly tolerant to difficult brines in operations requiring large water volumes, such as unconventional reservoirs. The concentration of IDS in these brines can be equal to or less than about 250,000 ppm, alternatively equal to or less than about 60,000 mg/L.

In embodiments, placement of the treatment fluid comprising a MAP and base fluid in the formation can be tailored to formation conditions, specifically temperature. The solubility of the MAP determines the release profile of the MAP (and resultant contact with a downhole surface) and this determines the longevity of the scale protection period for the contacted downhole surface.

Mature fields continue to play a vital role in overall global oil production. Consistent need for stimulation or re-stimulation of these fields provides a lower cost option for continuous and/or improved production from mature wells. In embodiments, the treatment fluids comprising a MAP and base fluid can be used in new injection well completions or re-stimulations where mobility of oil remains difficult or where scaling of conductive channels presents infectivity or production losses. With the known capabilities of the treatment fluids disclosed herein, additional asset recovery can be achieved leading to higher production of new or existing wells and overall improved reservoir drainage in EOR applications.

The methods of treatment and compositions of the present disclosure may advantageously (i) decrease capillary pressure within a subterranean formation, (ii) reduce interfacial tension between oil and water, (iii) alter wettability of at least a portion of the subterranean formation, (iv) enhance differential dissolution of mineral surfaces carbonate-rich, (v) enhance wetting of siliceous surfaces without dissolution of silicates minerals, or (vi) and a combination thereof In some embodiments, introduction of a treatment fluid of the type disclosed herein results in a. decrease in the interfacial tension between hydrocarbon and water in the formation by from about 50% to about 500% subsequent to placement of the wellbore servicing composition.

In some embodiments, a composition. comprising an aqueous phase; an oil phase comprising at a base fluid; an organic solvent; one or more surfactants; and at least one phosphorous-containing material comprising a metallated diacetoaminophosphonate or a non-metallated diacetoaminophosphonate is introduced to a formation during an FOR process. In some embodiments, Windsor TYPE IV microemulsions is formulated wherein the metallated phosphonate is “encapsulated” into a surfactant blend that may maximize its depth of penetration. into the formation and matrix.

Treatment fluids of the present disclosure have not been utilized in EOR applications and the experimental data presented herein indicate that there is no similar fluid/chemical agent that can fill the gap between a mixture of surfactant(s) and (phosphonoarkyl)aminopolycarboxylic acids and the treatment fluids disclosed herein.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

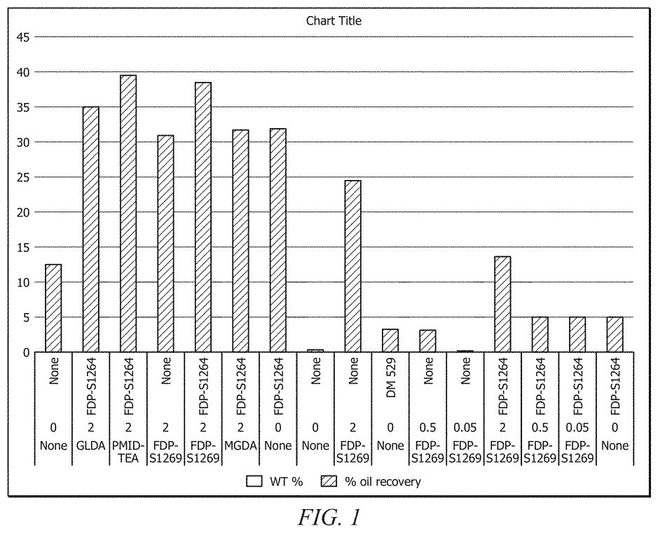

A spontaneous imbibition experiment was performed to determine the extent of oil recovery when using a treatment fluid of the type disclosed herein. Specifically, the oil produced or recovered from a core was measured as a function of time (days) for treatment fluids of the type disclosed herein (i.e., comprising a MAP). For simplicity these are designated as inventive formulations. The results for the treatment fluids of a type disclosed herein was compared to the results obtained when using compounds like MGDA and GLDA. For these experiments, the treatment fluid contained the potassium salt of PMIDA at 6.5-7.0 which was used alone or in combination with a surfactant of the type disclosed herein. The results are presented in Table 1 and FIG. 1.

TABLE 1

| | | Surfactant | | % oil |
|---|---|---|---|---|
| Additive | wt % | Blend | wt % | recovery |
| None | 0 | None | 0 | 13 |
| GLDA | 2 | Yes | 0.2 | 35 |
| PMIDA-TEA | 2 | Yes | 0.2 | 39 |
| INVENTIVE | 2 | None | 0 | 31 |
| FORMULATION | | | | |
| INVENTIVE | 2 | Yes | 0.2 | 38 |
| FORMULATION | | | | |
| WITH | | | | |
| SURFACTANT | | | | |
| MGDA | 2 | Yes | 0.2 | 32 |
| None | 0 | Yes | 0.2 | 32 |
| None | 0 | none | 0 | 0 |
| CFE | 2 | None | 0 | 25 |
| None | 0 | Yes | 0.1 | 3 |
| INVENTIVE | 0.5 | None | 0 | 3 |
| FORMULATION | | | | |
| INVENTIVE | 0.05 | None | 0 | 0 |
| FORMULATION | | | | |
| INVENTIVE | 2 | Yes | 0.1 | 14 |
| FORMULATION | | | | |
| INVENTIVE | 0.5 | Yes | 0.1 | 5 |
| FORMULATION | | | | |
| INVENTIVE | 0.05 | Yes | 0.1 | 5 |
| FORMULATION | | | | |
| None | 0 | Yes | 0.1 | 5 |

TEA = triethanoiamine
CFE = is a carbonate formation enhancer comprising a phosphonoalkyl aminopolycarboxylic acid salt

The spontaneous imbibition experiments were conducted using an Indiana limestone (>98% CaCO₃) outcrop core, with a 45° API crude. This core was selected because it is a homogeneous high porosity (10-14%) core, more representative of a conventional reservoir.

### Example 2

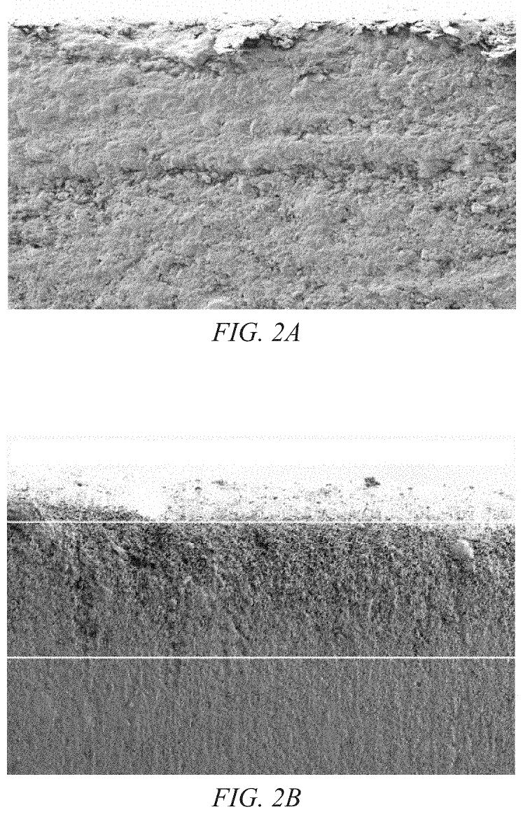

The effect of a treatment fluid is demonstrated by the investigations carried out where a formation material was subjected to brine of a treatment fluid for 3 months and then scanning electron microscopy (SEM) was used to image the cross-section and determine the depth of penetration for the fluid. For brine alone or surfactant alone no significant penetration into the matrix was observed. Referring to FIGS. 2A and 2B, a treatment fluid had a noticeable penetration depth of 227 microns and more effective mobilization hydrocarbon through rapid water-wetting of oil coated surfaces. The treatment fluids of the type disclosed herein were found to rapidly deliver surfactants, including non-emulsified surfactants, and compositions into the surface areas or sections of a subterranean formation that do not get exposed to a treatment fluid, as compared to another composition lacking a MAP.

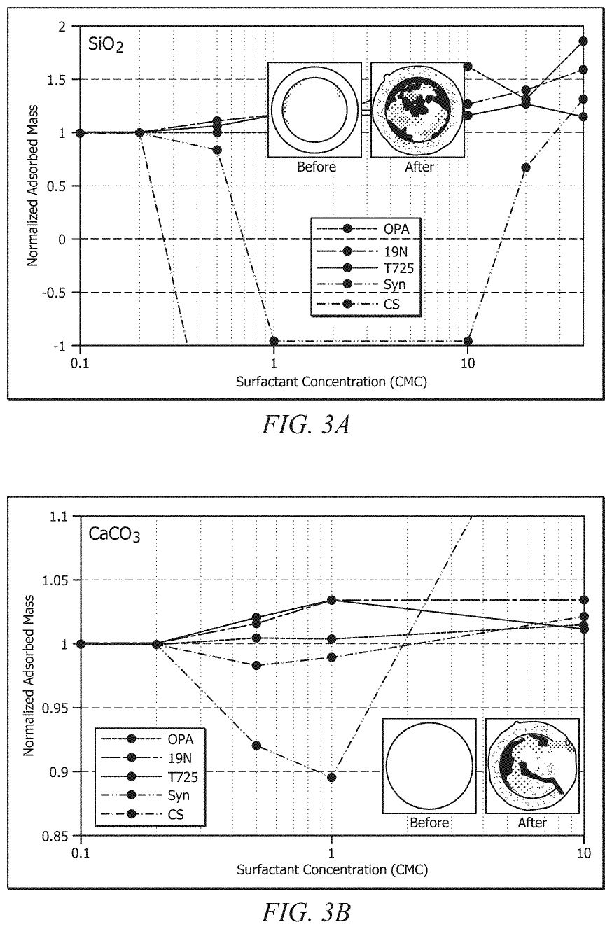

The treatment fluid was further investigated using coated and aged oil on a quartz and carbonate surface. In these experiments, traditional surfactants alone were only moderately effective at removing the oil with a continuous injection of fluid across the surface. A treatment fluid of the present disclosure rapidly altered the wettability and mobilized the hydrocarbon as shown in FIGS. 3A and 3B.

Further it was found that reactive etching of the surface by a treatment fluid of the type disclosed herein releases a lesser amount of fines, observed in the spontaneous imbibition experiments, into the fluid for better sweep efficiency. LSW released fines from the clays. The amount released depended on the clay content and how well the salinity matched the critical salinity to promote detachment. Conventionally, critical salinity is considered to be 1M monovalent salt. In contrast, a treatment fluid of the type disclosed herein, etched a small volume ˜0.1% of the surface, this is expected to mobilize small fragments of rock to work as the viscosifiers and diverts to improve the sweep efficiency (e.g., amount of hydrocarbon removed as a function of the amount of injectant injected).

### Example 3

In order to validate a treatment fluid of the type disclosed herein comprising a MAP and base fluid) for scale inhibiting properties in an acidizing of injector wells, a series of tests were conducted using bottle tests and the dynamic scale loop to elucidate efficacy towards scale inhibition.

Bottle tests using a fluid containing spent HCl acid and as the MAP, a potassium salt of PMIDA, combined in conjunction with scaling brines were used to explore efficacy of this fluid as a scale inhibitor. This series of tests mimic an acid stimulation for injector wells where the spent acid will minimize scaling tendencies in conductive pathways from injector to producing wells.

The scaling bottle test used a calcium carbonate scaling brine where the anionic brine was soluble 0.01M potassium carbonate (K₂CO₃) and the cationic brine contained soluble 0.01M calcium chloride (CaCl₂) to generate CaCO₃ as an insoluble scale. Specifically, 0.1M Calcium chloride was added dropwise to a 10 mL solution of 0.01M K₂CO₃. Upon the addition of 3 drops, the clear solution became slightly cloudy indicating the scale had formed.

Calcium chloride was added dropwise to a 10 mL solution containing 1 mL of 0.1M K₂CO₃ and 9 mL of 6-fold dilution of the spent potassium salt of PMIDA (spent fluid was generated from a previously conducted core flow experiment using Indiana limestone, 15% HCl, 7% of the treatment fluid, at 200° F. contained in a Hassler cell using confining pressure of 2,500 psi, back pressure of 1,250 psi, and flowed at 3 mL/min injection rate). After the addition of 71 drops of CaCl₂ the solution turned cloudy. Taking into consideration dilution of the spent fluid, the treatment fluid enabled scale (calcium carbonate for this example) inhibition was observed at levels that were greater than about 150 times that of the control.

Scale control of native fluids, water, was investigated using treatment fluids of the type disclosed herein. Specifically, (1) a potassium salt of PMIDA and (2) a potassium salt of PMIDA and the free base, respectively), were used in the absence of spent acid and a scaling brine was injected at temperature and pressure through a dynamic scaling loop. Similar to the bottle tests, two separate streams of anionic and cationic brines were injected under pressure and temperature into a capillary tube to observe scaling (indicated by a pressure increase from restriction of flow by scale buildup on the capillary tube wall). The formulation of the anionic and cationic brines is shown in Table 2.

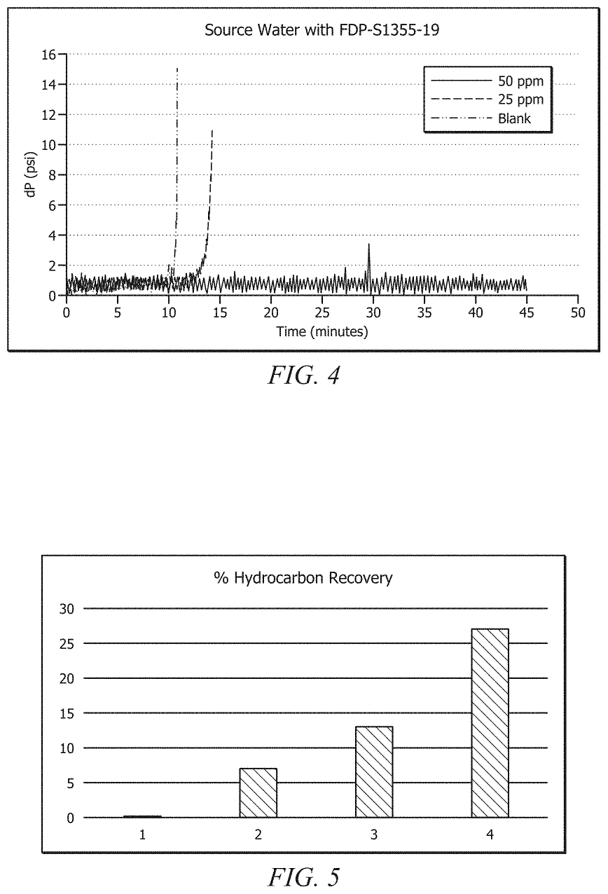

The results are depicted in FIG. 4 which is a plot of the differential pressure as a. function of time. For the control sample, both brines were flowed for 10 minutes until a pressure increase (scale) was observed. To the anionic brine was added a MAP (the potassium salt of PMIDA) at a concentration sufficient to provide a final delivered concentration of 25 ppm. As with the control, the fluids were flowed/combined until a pressure increase was observed at 14 minutes. At 25 ppm, the addition of the MAP gave a 40% improvement compared to the control. Further, 50 ppm of the MAP gave efficient scale control of the fluid resulting in no increase of pressure after greater than 45 minutes.

TABLE 2

| Source | Water Analysis (mg/L) |
|---|---|
| Specific Gravity | 1.186 |
| pH | 7.36 |
| Chloride | 161,109 |
| Sulfate | 270 |
| Bicarbonate (Alkalinity) | 1,200 |
| Aluminum | 4.09 |
| Boron | 336 |
| Barium | 21.6 |
| Calcium | 15,400 |
| Iron | 0.885 |
| Potassium | 5,810 |
| Magnesium | 879 |
| Sodium | 79,400 |
| Strontium | 1,140 |
| TDS | 258,258 |
| TSS (mg/L) | 98 |

### Example 4

The ability of a treatment fluid of the type disclosed herein to enhance oil recovery was investigated using a calcite core. In this experiment, a calcite core was vacuum saturated in crude oil (Niobrara 45 API) and aged at temperature to yield an oil-wetted core sample. The cores were placed in an Amott cell and the corresponding fluid was introduced. The cores were allowed to age at room temperature in the fluid and the oil recovered from the core was recorded as a function of time. A surfactant or surfactant composition was a sample component as indicated. The surfactant or surfactant composition was of the type disclosed herein. The specific formulations and percentage oil recovery observed are tabulated in Table 3 and presented as a graph in FIG. 5. For the control sample, the addition of 2 wt % KCl was introduced to the oil-saturated core resulted in a recovery of less than 1% after 100 hours. The surfactant in 2 wt % KCl was introduced to the oil saturated core and resulted in an oil recovery of 7% after 100 hours. Using a MAP and surfactant in 2 wt % KCl yielded 13% oil recovery in the same timeframe. The synergistic effect of adding MAP and surfactant gave 28% recovery at the same endpoint.

TABLE 3

| SAMPLE | MAP | Wt. | Surfactant | | % Oil |
|---|---|---|---|---|---|
| NO | Additive | % | Blend | wt % | Recovery |
| 1 | None | 0 | None | 0 | <1 |
| 2 | None | 0 | Yes | 0.2 | 7 |
| 3 | Yes | 2 | None | 0 | 13 |
| 4 | Yes | 2 | Yes | 0.2 | 28 |

### Additional Disclosure—Part I

The following are non-limiting, specific embodiments in accordance and with the present disclosure:

A first embodiment which is a method of enhanced oil recovery comprising placing into a subterranean formation a treatment fluid comprising (i) a compound comprising a phosphonoalkyl moiety; and (ii) a base fluid wherein a pH of the treatment fluid ranges from about 5 to about 9.

A second embodiment which is the method of the first embodiment wherein the compound comprising a phosphonoalkyl moiety is a phosphonoalkyl aminopolycarboxylic acid having the general formula

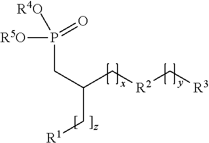

where R¹ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonate, or a hydrogen atom;
R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom;
R³ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonoalkyl/amine, or a hydrogen atom;
R⁴ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom;
R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom; and
x is 1 to 6; y is 0 to 6; and z is 1-6.

A third embodiment which is the method of any of the first through second embodiments wherein the compound comprising a phosphonoalkyl moiety comprises N-(phosphonomethyl) iminodiacetic acid (PMIDA, N-(carboxymethyl)-N-(phosphonomethyl)glycine, glycine, N,N′-1,2-ethanediylbis(N-(phosphonomethyl), glyphosine, aminotrimethylene phosphonic acid, sodium aminotris(methylenephosphonate), N-(2-hydroxyethyl)iminobis (methylphosphonic acid), phosphonic acid, P,P′-((2-proper-1-ylimino)bis(methylene))bis-phosphonic acid, P,P′,P″-(nitrilotris(methylene))tris-, (nitrilotris(methylene))trisphosphonic acid, ((methylimino)-dimethylene)bisphosphonic acid, P,P′,P″,P′″-(oxybis(2,1-ethanediyinitrilobis(methylene))tetrakis-((propylimino)bis(methylene))diphosphonic acid, P,P′, P″-(nitrilotris(methylene))tris-(ethylenedinitrilo)-tetramethylenephosphonic acid, ethylene-bis(nitrilodimethylene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl) amino)hexanoic acid, (phenylmethypimino)bis(methylene)bisphosphonic acid, phosphonobutane tricarboxylic acid, 2-hydroxyphosphono dicarboxylic acid or, a combination thereof.

A fourth embodiment which is the method of any of the first through third embodiments wherein the compound comprising a phosphonoalkyl moiety further comprises a counteraction.

A fifth embodiment which is the method of the fourth embodiment wherein the countercation comprises a metal selected from the group consisting of lithium, sodium, potassium, rubidium, cesium, magnesium, calcium, strontium, barium, iron, manganese, cobalt, nickel, copper, gallium, indium, aluminum and a combination thereof.

A sixth embodiment which is the method of the fourth embodiment wherein the countercation comprises a nonmetal selected from the group consisting of hydrogen ions, ammonium ions, tetraalkylammonium ions, tetraalkylphosphonium ions, a mono-, di-, or tri-alkanolamine wherein the alkyl species of the alkanol functionality can be methyl-, ethyl-, an isomer of propyl or an isomer of butyl, a nucleophile, an electrophile, a Lewis acid, a Lewis base, a Bronsted acid, a Bronsted base, an adduct of a stable complex ion, an electron donor and a combination thereof.

A seventh embodiment which is the method of any of the first through sixth embodiments wherein the compound comprising a phosphonoalkyl moiety is present in an amount of from about 5 mg/L (0.05% wt.) to about 15,000 mg/L (15% wt.) based on the total weight of the treatment fluid.

An eighth embodiment which is the method of any of the first through seventh embodiments wherein the base fluid comprises an aqueous fluid.

A ninth embodiment which is the method of the eighth embodiment wherein the aqueous fluid comprises fresh water, salt water, deionized water, produced water, flowback water, brackish water, brine, seawater or a combination thereof.

A tenth embodiment which is the method of the eighth embodiment wherein the aqueous fluid comprises sodium bromide, calcium chloride, calcium bromide, cesium bromide, zinc bromide, potassium chloride, sodium chloride, a carbonate salt, a sulfonate sale, sulfite salts, a phosphate salt, a phosphonate salt, a magnesium salt, a bromide salt, a formate salt, an acetate salt, thiophosphate salts, a nitrate salt, a nitrite salt, an ammonium salt, or a combination thereof

An eleventh embodiment which is the method of any of the first through tenth embodiments wherein the base fluid is present in an amount of from about 0.01 wt. % to about 99 wt. % based on the total weight of the treatment fluid.

A twelfth embodiment which is the method of any of the first through eleventh embodiments further comprising a surfactant.

A thirteenth embodiment which is the method of the twelfth embodiment wherein the surfactant comprises a Guerbet alcohol.

A fourteenth embodiment which is the method of the thirteenth embodiment which is the method of the wherein the Guerbet alcohol comprises a C₈ to C₂₅ β-alkoxylated dimer alcohol.

A fifteenth embodiment which is the method the thirteenth embodiment wherein the C₈ to C₂₅ β-alkoxylated dimer alcohol comprises 2-butyloctanol, 2-hexyldecanol or a combination thereof.

A sixteenth embodiment which is the method of the twelfth embodiment wherein the surfactant further comprises a demulsifying surfactant.

A seventeenth embodiment which is the method of any of the first through sixteenth embodiments wherein the treatment fluid further comprises partially hydrolyzed polyacrylamide, terpolymers derived of monomers containing esters and amides of alcohols, alkoxylated alcohols, propoxylated alcohols, amines, alkyoxylated amines, propoxylated amities, alkyl amines, alkyl sulfonates, alkyl phosphonates, quaternary amines, alkylsilines, or a combination thereof.

An eighteenth embodiment which is the method of any of the first through seventeenth embodiments wherein the subterranean formation comprises a fractured formation, a high-contrast formation or both.

A nineteenth embodiment which is the method of any of the first through eighteenth embodiments wherein the treatment fluid is polymer-free.

A twentieth embodiment which is the method of any of the first through nineteenth embodiments wherein the treatment fluid comprises less than about 0.6 mol/L ethylenediaminetetraacetic acid (EDTA), diethylenetriaminepentaacetic acid (DTPA), glutamic acid di-acetate (GLDA), methylglycinediacetic acid (MGDA), ethylenediamine-N,N′-disuccinic acid (EDDS), hydroxyiminodisuccinic acid (HIDS), hydroxyethylethylenediaminetriacetic acid (HEDTA), pentasodium diethylenetriaminepentaacetate (Na₅DPTA, DPTA), pentapotassium diethylenetriaminepentaacetate (K₅DPTA, DPTA), diethylenetriaininepen aacetic acid (H₅DPTA, DPTA), N,N-diacetic acid, tetrasodium (GLDA Na₄), glutamic acid, β-alanine diacetic acid (β-ADA), polyamino disuccinic acids, N-bis[2-(1,2-dicarboxyethoxy)ethyl]glycine (BCA6), N-bis[2-(1,2-dicarboxyethoxy)ethyl]aspartic acid (BCA5), N-bis[2-(1,2-dicarboxyethoxy)ethyl]methylglycine (MCBA5), N-tris[(1,2-dicarboxyethoxy)ethyl]amine (TCA6), N-bis[2-(carboxymethoxy)ethyl]glycine (BCA3), N-bis[2-(methylcarboxymethoxy)ethyl]glycine (MCBA3), N-methyliminodiacetic acid (MIDA), iminodiacetic acid (IDA), N-(2-acetamido)iminodiacetic acid (ADA), hydroxymethyl-iminodiacetic acid, 2-(2-carboxyethylamino) succinic acid (CEAA), 2-(2-carboxymethylamino) succinic acid (CMAA), diethylenetria ine-N,N″-disuccinic acid, triethylenetetranine-N,N′″-disuccinic acid, 1,6-hexamethylenediamine-N,N′-disuccinic acid, tetraethylenepentamine-N,N″″-disuccinic acid, 2-hydroxypropylene-1,3-diamine-N,N′-disuccinic acid, 1,2-propylenediamine-N,N-disuccinic acid, 1,3-propylenediamine-N,N′-disuccinic acid, cis-cyclohexanediamine-N,N′-disuccinic acid, trans-cyclohexanediamine-N,N′-disuccinic acid, ethylenebis(oxyethylenenitrilo)-N,N′-disuccinic acid, glucoheptanoic acid, cysteic acid-N,N-diacetic acid, cysteic acid-N-monoacetic acid, alanine-N-monoacetic acid, N-(3-hydroxysuccinyl) aspartic acid, N-[2-(3-hydroxysuccinyl)]-L-serine, aspartic acid-N,N-diacetic acid, aspartic acid-N-monoacetic acid, hydroxyethyliminodiacetate (HEIDA), iminodiacetic acid (IDA), nitrilotriacetic acid (NTA), polyhydroxy carboxylic acids, citric acid, glycolic acid, lactic acid, maleic acid, gluconic acid, glucaric acid, salts thereof or a combination thereof.

A twenty-first embodiment which is the method of any of the first through twentieth embodiments wherein the pH of the treatment fluid ranges from about 6 to about 8.

### Additional Disclosure—Part II

The following are non-limiting, specific embodiments in accordance and with the present disclosure:

A first embodiment which is a wellbore servicing composition comprising:
a) a pore-connectivity enhancer comprising a phosphonoalkyl moiety;
b) a surfactant composition comprising a fatty acid alkoxylate, an amine oxide, alkanolamide, an alkoxylated alcohol, an alkylamine alkoxylate, an alkyl glycoside surfactant or a combination thereof; and
c) a base fluid, wherein the composition has a pH of from about 5 to about 9 or from about 6.5 to about 8.5.

A second embodiment which is the wellbore servicing composition of the first embodiment wherein the pore-connectivity enhancer comprising a phosphonoalkyl moiety is a phosphonoalkyl aminopolycarboxylic acid having the general formula

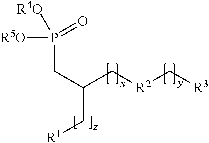

where R¹ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonate, or a hydrogen atom;
R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom;
R³ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonoalkyl/amine, or a hydrogen atom;
R⁴ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom;
R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom; and
x is 1 to 6; y is 0 to 6; and z is 1-6.

A third embodiment which is the wellbore servicing composition of any of the first through second embodiments wherein the pore-connectivity enhancer comprising a phosphonoalkyl moiety comprises n-(phosphonomethyl) iminodiacetic acid (PMIDA, N-(carboxymethyl)-N-(phosphonomethyl)glycine, glycine, N,N′-1,2-ethanediylbis(N-(phosphonomethyl), glyphosine, aminotrimethylene phosphonic acid, sodium aminotris(methylenephosphonate), N-(2-hydroxyethyl)iminobis (methylphosphonic acid), phosphonic acid, P,P′-((2-propen-1-ylimino)bis(methylene))bis-phosphonic acid, P,P′,P″-(nitrilotris(methylene))tris-(nitrilotris(methylene))trisphosphonic acid, ((methylimino)dimethylene)bisphosphonic acid, P,P′,P″,P′″-(oxybis(2,1-ethanediylnitrilobis(methylene))tetrakis-((propylimino)bis(methylene))diphosphonic acid, P,P′,P″-(nitrilotris(methylene))tris-(ethylenedinitrilo)-tetramethylenephosphonic acid, ethylene-bis(nitrilodimethyene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl) amino)hexanoic acid, (phenylmethyl)imino)bis(methylene)bisphosphonic acid, phosphonobutane tricarboxylic acid, 2-hydroxyphosphono dicarboxylic acid, a sodium salt thereof, a potassium salt thereof, an ammonium salt thereof or a combination thereof.

A fourth embodiment which is the wellbore servicing composition of any of first through third embodiments wherein the pore-connectivity enhancer comprising a phosphonoalkyl moiety is present in an amount of from about 5 mg/L (0.05% wt.) to about 15,000 mg/L (15% wt.) based on the total weight of the composition.

A fifth embodiment which is the wellbore servicing composition of any of the first through fourth embodiments wherein the base fluid comprises an aqueous fluid.

A sixth embodiment which is the wellbore servicing composition of the fifth embodiment wherein the aqueous fluid comprises fresh water, salt water, deionized water, produced water, flowback water, brackish water, brine,seawater or a combination thereof.

A seventh embodiment which is the wellbore servicing composition of any of the fifth through sixth embodiments wherein the aqueous fluid comprises sodium bromide, calcium chloride, calcium bromide, cesium bromide, zinc bromide, potassium chloride, sodium chloride, a carbonate salt, a sulfonate sale, sulfite salts, a phosphate salt, a phosphonate salt, a magnesium salt, a bromide salt, a formate salt, an acetate salt, thiophosphate salts, phosphate salts, phosphonate salts, a nitrate salt or a combination thereof.

An eighth embodiment which is the wellbore servicing composition of any of the fifth through seventh embodiments wherein the aqueous fluid is present in an amount of from about 0.01 wt. % to about 99 wt. % based on the total weight of the wellbore servicing composition.

A ninth embodiment which is the wellbore servicing composition of any of the first through eighth embodiments wherein the base fluid comprises the rest of the composition when all other components are taken into account.

A tenth embodiment which is the wellbore servicing composition of any of the first through ninth embodiments wherein the pore-connectivity enhancer comprising a phosphonoalkyl moiety further comprises a countercation.

An eleventh embodiment which is the wellbore servicing composition of any of the first through tenth embodiments wherein the countercation comprises a metal selected from the group consisting of lithium, sodium, potassium, rubidium, cesium, magnesium, calcium, strontium, barium, chromium, iron, manganese, cobalt, nickel, copper, gallium, indium, aluminum and a combination thereof.

A twelfth embodiment which is the wellbore servicing composition of any of the first through eleventh embodiments wherein the countercation comprises a nonmetal selected from the group consisting of hydrogen ions, ammonium ions, tetraalkylammonium ions, tetraalkylphosphonium ions, a mono-, di-, or tri-alkanolamine wherein the alkyl species of the alkanol functionality can be methyl-, ethyl-, an isomer of propyl or an isomer of butyl; a nucleophile; a Lewis base, a Bronsted base; an adduct of a stable electron donor-electron and a combination thereof.

A thirteenth embodiment which is the wellbore servicing composition of any of the first through twelfth embodiments further comprising a polymer.

A fourteenth embodiment which is the wellbore servicing composition of the thirteenth embodiment wherein the polymer comprises partially hydrolyzed polyacrylamide, terpolymers derived of monomers containing esters and amides of alcohols, alkoxylated and propoxylated alcohols, amines, alkyoxylated and propoxylated amines, alkyl amines, alkyl sulfonates, alkyl phosphonates, quaternary amines, alkylsilines, or a combination thereof

A fifteenth embodiment which is the wellbore servicing composition of any of the thirteenth through fourteenth embodiments wherein the polymer is present in an amount of from about 0.05 wt. % to about 10% wt. based on the total weight of the wellbore servicing composition.

A sixteenth embodiment which is the wellbore servicing composition of any of the first through fifteenth embodiments wherein the composition comprises less than about 3 wt. % polymer based on the total weight of the composition.

A seventeenth embodiment which is the wellbore servicing composition of any of the first through twelfth embodiments wherein the composition is polymer-free.

An eighteenth embodiment which is the wellbore servicing composition of any of the first through seventeenth embodiments wherein the surfactant composition comprises a Guerbet alcohol.

A nineteenth embodiment which is the wellbore servicing composition of any of the first through eighteenth embodiments wherein the Guerbet alcohol comprises a C₈ to C₂₅ β-alkoxylated dimer alcohol.

A twentieth embodiment which is the wellbore servicing composition of the nineteenth embodiment wherein the C₈ to C₂₅ β-alkoxylated dimer alcohol comprises an ethoxylate moiety, a propoxylate moiety or a combination thereof.

A twenty-first embodiment which is the wellbore servicing composition of any of the nineteenth through twentieth embodiments wherein the C₈ to C₂₅ β-alkoxylated dimer alcohol has an ethoxylate moiety present in an amount of from about 10 mole percent (mol. %) to about 90 mol % based on the total moles of the C₈ to C₂₅ β-alkoxylated dimer,

A twenty-second embodiment. which is the wellbore servicing composition of any of the nineteenth through twenty-first embodiments wherein the C₈ to C₂₅ β-alkoxylated dimer alcohol has a propoxylate moiety present in an amount of from about 10 mole percent (mol. %) to about 90 mol % based on the total moles of the C₈ to C₂₅ β-alkoxylated dimer.

A twenty-third embodiment which is the wellbore servicing composition of any of the nineteenth through twenty-second embodiments wherein the C₈ to C₂₅ β-alkoxylated dimer alcohol has an ethoxylate moiety and a propoxylate moiety present in ratio of from about 4:1, alternatively from about 2:1, alternatively from about 1:1, alternatively from about 1:2 or alternatively from about 1:4.

A twenty-fourth embodiment which is the wellbore servicing composition of any of the nineteenth through twenty-third embodiments wherein the C₈ to C₂₅ β-alkoxylated dimer alcohol comprises 2-butyloctanol, 2-hexyldecanol or a combination thereof

A twenty-fifth embodiment which is the wellbore servicing composition of any of the first through twenty-fourth embodiments wherein the surfactant composition further comprises a demulsifying surfactant.

A twenty-sixth embodiment which is the wellbore servicing composition of the twenty-fifth embodiment wherein the demulsifying surfactant comprises, polyols, alkoxylated polyols, resin alkoxylates, alkoxylated phenol formaldehydes alkyl resin, polyaminopolyethers, polyether amines, or a combination thereof.

A twenty-seventh embodiment which is the wellbore servicing composition of any of the first through twenty-sixth embodiments further comprising a water-immiscible fluid.

A twenty-eighth embodiment which is the wellbore servicing composition of the twenty-seventh embodiment wherein the water-immiscible fluid is an oleaginous fluid, a hydrocarbon fluid, a natural or synthetic oil or a combination thereof.

A twenty-ninth embodiment which is the wellbore servicing composition of the twenty-seventh embodiment wherein the water-immiscible fluid comprises a C₅ to C₅₀ hydrocarbon, a terpene, d-limonene, a dipentene, a pinene, a terpene obtained from the essence of oranges, ethyl lactate, an oil of turpentine, isobutyl alcohol, liner or branched distillates, methyl-9-deonate, 1-dodecyl-2-pyrollidinone, dimethyl-2-methylglutarate, an ethoxylated, propoxylated terpene, N,N-dimethyl 9-decenamide, triethyl citrate, diethyl carbonate, n-methylpyrrolidone, an isoprene adduct, an isomer of an isoprene adduct, a C₅ to C₅₀ alkane, a C₅ to C₅₀ isoalkane, a C₅ to C₅₀ alkene, a silicone oil, a C₁ to C₅ alkyl ester of a substituted or unsubstituted C₁ to C₂₀ carboxylic acid or a combination thereof.

A thirtieth embodiment which is the wellbore servicing composition of any of the twenty-seventh through twenty-ninth embodiments wherein the water-immiscible fluid is present in an amount of from about 0.01 wt. % to about 99.9 wt. % based on the total weight of the wellbore servicing composition.

A thirty-first embodiment which is the wellbore servicing composition of any of the first through thirtieth embodiments further comprising an alcohol.

A thirty-second embodiment which is the wellbore servicing composition of the thirty-first embodiment wherein the alcohol comprises from about 0.01 wt. % to about 5 wt. % based on the total weight of the wellbore servicing composition.

A thirty-third embodiment which is the wellbore servicing composition of any of the first through thirty-second embodiments (a) comprising less than about 10, 1.0, 0.1. 0.01. or 0.001 wt. % of one or more chelants or (b) having no (zero) chelants.

A thirty-fourth embodiment which is the wellbore servicing composition of any of the first through thirty-third embodiments comprising less than about 10, 1.0, 0.1, 0.01, or 0.001 wt. % of ethylenediaminetetraacetic acid (EDTA), diethylenetriaminepentaacetic acid (DTPA), glutamic acid di-acetate (GILDA), methylglycinediacetic acid (MGDA), salts thereof or a combination thereof.

A thirty-fifth embodiment which is a method of making the wellbore servicing composition of any of the first through thirty-fourth embodiments comprising simultaneously contacting (i) pore-connectivity enhancer comprising a phosphonoalkyl moiety, (ii) surfactant composition; (iii) base fluid, (iv) the water-immiscible fluid and (v) the alcohol to form the wellbore servicing composition, wherein the components (i) to (v) can be combined or contacted in any sequence.

A thirty-sixth embodiment which is a method of making the wellbore servicing composition of any of first through thirty-fourth embodiments comprising contacting (i) the pore-connectivity enhancer comprising a phosphonoalkyl moiety; (ii) the surfactant composition and (iii) the base fluid to form a first mixture; and contacting the first mixture with (iv) the water-immiscible fluid and (v) the alcohol to form the wellbore servicing composition.

A thirty-seventh embodiment which is a method of making the wellbore servicing composition of any of the first through thirty-fourth embodiments comprising simultaneously contacting (i) the pore-connectivity enhancer comprising a phosphonoalkyl moiety present in an amount of from about 0.1 wt. % to about 10 wt. % based on a total weight of the composition, (ii) the surfactant composition and (iii) the base fluid to form the wellbore servicing composition, wherein the components (i) to (iii) can be combined or contacted in any sequence.

A thirty-eighth embodiment which is a method of servicing a wellbore comprising placing the wellbore servicing composition of any of the first through thirty-seventh embodiments in a wellbore penetrating a subterranean formation.

A thirty-ninth embodiment which is the method of the thirty-eighth embodiment wherein a capillary pressure in the formation is advantageously decreased subsequent to placement of the wellbore servicing composition.

A fortieth embodiment which is the method of any of the thirty-eighth through thirty-ninth embodiments wherein an interfacial tension between hydrocarbon and water in the formation is decreased by from about 50% to about 500% subsequent to placement of the wellbore servicing composition.

A forty-first embodiment which is the method of any of the thirty-eighth through fortieth embodiments wherein a wettability in at least a portion of the formation is advantageously altered subsequent to placement of the wellbore servicing composition,

A forty-second embodiment which is a method of any of the thirty-eighth through forty-first embodiments wherein a dissolution of mineral surfaces in the formation is enhanced subsequent to placement of the wellbore servicing composition.

A forty-third embodiment which is the method of any of the thirty-eighth through forty-second embodiments wherein the wellbore servicing composition is placed in the wellbore as part of an enhanced oil recovery operation or a tertiary oil recovery technique.

A forty-fourth embodiment which is the method of the forty-third embodiment wherein during the enhanced oil recovery, the wellbore servicing composition is placed into the subterranean formation via one or more injection wells and travels a distance into the subterranean formation in a direction of one or more recovery/production wells.

A forty-fifth embodiment which is the method of the forty-third embodiment wherein the enhanced oil recovery (EOR) comprises thermal injection such as steam injection, steam flooding, or fire flooding (e.g., in situ combustion within the formation); gas (e.g., carbon dioxide, natural gas, or nitrogen) injection also referred to as miscible flooding; or chemical injection (e.g., water flooding with one or more chemical additives such as surfactants, polymers, alkaline or caustic agents, etc.).

A forty-sixth embodiment which is the method of the forty-third embodiment where the EOR process comprises cyclic injection using water or a foamed fluid containing chemical agents to enhance hydrocarbon recovery from the reservoir matrix into one or more injection wells followed by production from one or more production wells, or alternatively from a single production well.

A forty-seventh embodiment which is the method of the forty-third embodiment where the EOR process comprises cyclic injection using water or a foamed fluid containing the pore-connectivity enhancer comprising a phosphonoalkyl moiety (e.g., PMIDA and variants thereof) to enhance hydrocarbon recovery from the reservoir matrix in a multi well scenario where a plurality of wells in close proximity to each other are injected and produced in a pattern to help maintain reservoir pressure and enhance overall recovery from a larger reservoir utilizing multiple well interaction.

A forty-eighth embodiment which is the method of the forty-third embodiment wherein the EOR process comprises a non-fracturing injection mode.

A forty-ninth embodiment which is the method of the forty-eighth embodiment wherein the non-fracturing injection mode occurs through placement of coiled tubing in the wellbore.

A fiftieth embodiment which is the method of any of the forty-eighth through forty-ninth embodiments wherein the wellbore servicing composition is (i) not flowed back, (ii) not recovered or (iii) both.

A fifty-first embodiment which is the method of any of the thirty-eighth through fiftieth embodiments wherein the subterranean formation comprises a fractured carbonate reservoir, a sandstone reservoir, an unconventional reservoir or any combination thereof.

A fifty-second embodiment which is a method of servicing a wellbore comprising introducing a treatment fluid comprising a pore-connectivity enhancer comprising a phosphonoalkyl moiety; a surfactant composition comprising a fatty acid alkoxylate, an amine oxide, alkanolamide, an alkoxylated alcohol, an alkylamine alkoxylate, an alkyl glycoside surfactant or a combination thereof and a base fluid, wherein the composition has a pH of from about 5 to about 9 or from about 6.5 to about 8.5 and wherein introducing comprises thermal injection, gas injection or chemical injection.

A fifty-third embodiment which is a method of servicing a wellbore comprising introducing a treatment fluid comprising a pore-connectivity enhancer comprising a phosphonoalkyl moiety; a surfactant composition comprising a fatty acid alkoxylate, an amine oxide, alkanolamide, an alkoxylated alcohol, an alkylamine alkoxylate, an alkyl glycoside surfactant or a combination thereof; and a base fluid, wherein the composition has a pH of from about 6.5 to about 8.5 and wherein introducing comprises thermal injection, gas injection or chemical injection.

The subject matter having been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.: greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

We claim:

1. A method of enhanced oil recovery comprising:
placing into a subterranean formation a treatment fluid comprising (i) a compound comprising a phosphonoalkyl moiety; and (ii) a base fluid wherein a pH of the treatment fluid ranges from about 5 to about 9 wherein the treatment fluid is placed into the subterranean formation via one or more injection wells and travels a distance into the subterranean formation in a direction of one or more recovery/production wells.

2. The method of claim 1, wherein the compound comprising a phosphonoalkyl moiety is a phosphonoalkyl aminopolycarboxylic acid having the general formula 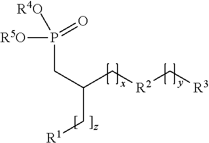
wherein R¹ is selected from an alkyl having from 1 to 10 carbon atoms, an alkenyl having from 1 to 10 carbon atoms, an alkynyl having from 1 to 10 carbon atoms, an acyl, an aryl, an acetate, a phosphonate, or a hydrogen atom;
R² is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, a phosphonoalkyl/amine, or a hydrogen atom;
R³ is selected from an alkyl having from 1 to 10 carbon atoms, an alkenyl having from 1 to 10 carbon atoms, an alkynyl having from 1 to 10 carbon atoms, an acyl, art aryl, an acetate, a phosphonoalkyl/amine, or a hydrogen atom;
R⁴ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom, a cobalt atom, a nickel atom, a copper atom, a gallium atom, an indium atom, or a hydrogen atom;
R⁵ is selected from an alkyl having from 1 to 6 carbon atoms, an alkenyl having from 1 to 10 carbon atoms, an alkynyl having from 1 to 10 carbon atoms, an acyl, an aryl, an acetate, a phosphonate, an ammonium cation, a lithium atom, a sodium atom, a potassium atom, a cesium atom, a magnesium atom, a calcium atom, a strontium atom, a barium atom, a chromium atom, an iron atom, a manganese atom a cobalt atom, a nickel atom, a copper atom, a gallium atom, an indium atom, or a hydrogen atom;
x is 1 to 6; y is 0 to 6; and z is 1-6.

3. The method of claim 1, wherein the compound comprising a phosphonoalkyl moiety comprises N-(phosphonomethyl) iminodiacetic acid (PMIDA, N-(carboxymethyl)-N-(phosphonomethyl)glycine, glycine, N,N-1,2-ethanediylbis(N-(phosphonomethyl), glyphosine, aminotrimethylene phosphonic acid, sodium aminotris(methylenephosphonate), N-(2-hydroxyethyl)iminobis (methylphosphonic acid), phosphonic acid, P,P′-((2-proper-1-ylimino)bis(methylene))bis-phosphonic acid, P,P′,P″-(nitrilotris(methylene))tris-(nitrilotris(methylene))trisphosphonic acid, ((methylimino)-dimethylene)bisphosphonic acid, phosphonic acid, P,P′,P″,P′″-(oxybis(2,1-ethanediylnitrilobis(methylene))tetrakis-((propylimino)bis(methylene))diphosphonic acid, P,P′,P″-(nitrilotris(methylene)tris-(ethylenedinitrilo)-tetramethylenephosphonic acid, ethylenebis(nitrilodimethylene)tetraphosphonic acid, (ethylenebis(nitrilobis(methylene)))tetrakisphosphonic acid, tetrasodium tetrahydrogen (ethane-1,2-diylbis(nitrilobis(methylene)))tetrakisphosphonate, 6-(bis(phosphonomethyl) amino)hexanoic acid, (phenylmethyl)imino)bis(methylene)bisphosphonic acid, phosphonobutane tricarboxylic acid, 2-hydroxyphosphono dicarboxylic acid or, a combination thereof.

4. The method of claim 1, wherein the compound comprising a phosphonoalkyl moiety further comprises a counteraction

5. The method of claim 4, wherein the countercation comprises a metal selected from the group consisting of lithium, sodium, potassium, rubidium, cesium, magnesium, calcium, strontium, barium, iron, manganese, cobalt, nickel, copper, gallium, indium, aluminum and a combination thereof.

6. The method of claim 4. wherein the countercation comprises a nonmetal selected from the group consisting of hydrogen ions, ammonium ions, tetraalkylammonium ions, tetraalkylphosphonium ions, a mono-, di-, or tri-alkanolamine wherein the alkyl species of the alkanol functionality can be methyl-, ethyl-, an isomer of propyl or an isomer of butyl, a nucleophile, an electrophile, a Lewis acid, a Lewis base, a Bronsted acid, a Bronsted base, an adduct of a stable complex ion, an electron donor and a combination thereof.

7. The method of claim 1, wherein the compound comprising a phosphonoalkyl moiety is present in an amount of from about 5 mg/L (0.05% wt.) to about 15,000 mg/L (15% wt.) based on the total weight of the treatment fluid.

8. The method of claim 1, wherein the base fluid comprises an aqueous fluid.

9. The method of claim 8, wherein the aqueous fluid comprises fresh water, salt water, deionized water, produced water, flowback water, brackish water, brine, seawater or a combination thereof.

10. The method of claim 8, wherein the aqueous fluid comprises sodium bromide, calcium chloride, calcium bromide, cesium bromide, zinc bromide, potassium chloride, sodium chloride, a carbonate salt, a sulfonate sale, sulfite salts, a phosphate salt, a phosphonate salt, a magnesium salt, a bromide salt, a formate salt, an acetate salt, thiophosphate salts, a nitrate salt, a nitrite salt, an ammonium salt, or a combination thereof.

11. The method of claim 1, wherein the base fluid is present in an amount of from about 0.01 wt. % to about 99 wt. % based on the total weight of the treatment fluid.

12. The method of claim 1, further comprising a surfactant.

13. The method of claim 12, wherein the surfactant comprises a Guerbet alcohol.

14. The method of claim 13, wherein the Guerbet alcohol comprises a C₈ to C₂₅ β-alkoxylated dimer alcohol.

15. The method of claim 13, wherein the C₈ to C₂₅ β-alkoxylated dimer alcohol comprises butyloctanol, 2-hexyldecanol or a combination thereof.

16. The method of claim 12, wherein the surfactant further comprises a demulsifying surfactant.

17. The method of claim 1, wherein the treatment fluid further comprises partially hydrolyzed polyacrylamide, terpolymers derived of monomers containing esters and amides of alcohols, alkoxylated alcohols, propoxylated alcohols, amines, alkyoxylated amines, propoxylated amines, alkyl amines, alkyl sulfonates, alkyl phosphonates, quaternary amines, alkylsilines, or a combination thereof.

18. The method of claim 1, wherein the subterranean formation comprises a fractured formation, a high-contrast formation or both.

19. The method of claim 1, wherein the treatment fluid is polymer-free.

20. The method of claim 1, wherein the treatment fluid comprises less than about 0.6 mol/L ethylenediaminetetraacetic acid (EDTA), diethylenetriaminepentaacetic acid (DTPA), glutamic acid di-acetate (GLDA), methylglycinediacetic acid (MGDA), ethylenediamine-N,N-disuccinic acid (EDDS), hydroxyiminodisuccinic acid (HIDS), hydroxyethylethylenediaminetriacetic acid (HEDTA), pentasodium diethylenetriaminepentaacetate (Na₅DPTA, DPTA), pentapotassium diethylenetriaminepentaacetate (K₅DPTA, DPTA), diethylenetriaminepentaacetic acid (H₅DPTA, DPTA), N,N-diacetic acid, tetrasodium (GLDA Na₄), glutamic acid, β-alanine diacetic acid (β-ADA), polyamino disuccinic acids, N-bis[2-(1,2-dicarboxyethoxy)ethyl]glycine (BCA6), N-bis[2-(1,2-dicarboxyethoxy)ethyl]aspartic acid (BCA5), N-bis[2-(1,2-dicarboxyethoxy)ethyl]methylglycine (MCBA5), N-tris[(1,2-dicarboxyethoxy)ethyl]amine (TCA6), N-bis[2-(carboxymethoxy)ethyl]glycine (BCA3), N-bis[2-(methylcarboxymethoxy)ethyl]glycine (MCBA3), N-methyliminodiacetic acid (MIDA), iminodiacetic acid (IDA), N-(2-acetamido)iminodiacetic acid (ADA), hydroxymethyl-iminodiacetic acid, 2-(2-carboxyethylamino) succinic acid (CEAA), 2-(2-carboxymethylamino) succinic acid (CMAA), diethylenetriamie-N,N″-disuccinic acid, triethylenetetramine-N,N′″-disuccinic acid, 1,6-hexamethylenediamine-N,N′-disuccinic acid, tetraethylenepentamine-N,N″″-disuccinic acid, 2-hydroxypropylene-1,3-diamine-N,N-disuccinic acid, 1,2-propylenediamine-N,N-disuccinic acid, 1,3-propylenediamine-N,N′-disuccinic acid, cis-cyclohexanediamine-N,N′-disuccinic acid, trans-cyclohexanediamine-N,N′-disuccinic acid, ethylenebis(oxyethylenenitrilo)-N,N′-disuccinic acid, glucoheptanoic acid, cysteic acid-N,N-diacetic acid, cysteic acid-N-monoacetic acid, alanine-N-monoacetic acid, N-(3-hydroxysuccinyl) aspartic acid, N-[2-(3-hydroxysuccinyl)]-L-serine, aspartic acid-N,N-diacetic acid, aspartic acid-N-monoacetic acid, hydroxyethyliminodiacetate (HEIDA), iminodiacetic acid (IDA), nitrilotriacetic acid (NTA), polyhydroxy carboxylic acids, citric acid, glycolic acid, lactic acid, maleic acid, gluconic acid, glucaric acid, salts thereof or a combination thereof.

21. The method of claim 1, wherein the pH of the treatment fluid ranges from about 6 to about 8.

22. A method of servicing a wellbore comprising:
introducing a treatment fluid comprising a pore-connectivity enhancer comprising a phosphonoalkyl moiety; a surfactant composition comprising a fatty acid alkoxylate, an amine oxide, alkanolamide, an alkoxylated alcohol, an alkylamine alkoxylate, an alkyl glycoside surfactant or a combination thereof; and
a base fluid, wherein the composition has a pH of from about 5 to about 9 and wherein introducing comprises thermal injection, gas injection or chemical injection.
